(19) United States
(12) Patent Application Publication
(10) Pub. No.: US 2026/0351979 A1
(43) Pub. Date: Nov. 5, 2026

(54) CONTROL APPARATUS, CONTROL METHOD, AND CONTROL PROGRAM

(71) Applicant: HONDA MOTOR CO., LTD., Minato-ku, Tokyo (JP)

(72) Inventors: Jumpei Tamura, Osaka-shi (JP); Satoshi Kodo, Tokyo (JP); Masayuki Arai, Tokyo (JP)

(21) Appl. No.: 19/486,970

(22) PCT Filed: Feb. 26, 2024
(86) PCT No.: PCT/JP2024/006824

§ 371 Date: Nov. 24, 2025

(30) Foreign Application Priority Data
May 26, 2023 (JP) 2023-087046

(51) Int. Cl. H02J 3/32; B60L 53/62; B60L 53/67

(52) U.S. Cl. CPC H02J 3/322; B60L 53/62; B60L 53/67

(57) ABSTRACT

A control apparatus is a control apparatus that controls charging-discharging of a vehicle group which includes a plurality of electric vehicles, the control apparatus including an acquisition portion that acquires an adjustment request amount indicating an output adjustable range which is a range in which output electric power of a charge-discharge device that performs charging-discharging of the electric vehicle is capable of being adjusted in response to a frequency variation of an electric power system, and a determination portion that determines, based on the adjustment request amount acquired by the acquisition portion, a second adjustment rate which is smaller than a first adjustment rate determined for the vehicle group as an adjustment rate used in a charge-discharge control of an electric vehicle included in the vehicle group.

### TECHNICAL FIELD

The present disclosure relates to a control apparatus, a control method, and a control program. The present application claims priority on Japanese Application No. 2023-087046, filed on May 26, 2023, and all of the contents described in the Japanese Application are incorporated herein by reference.

### BACKGROUND ART

The frequency of an electric power system changes in accordance with the balance of supply and demand of electric power around the reference frequency (50 Hz in eastern Japan). A risk of the balance of supply versus demand of electric power collapsing increases due to the increased introduction of renewable energy in which output easily changes such as solar power generation or wind power generation and due to natural disasters such as typhoons and earthquakes. In such an environment, a supply-demand adjustment market has been operating in Japan since 2021.

In the supply-demand adjustment market, an adjustment force is classified into three types which are a primary adjustment force, a secondary adjustment force, and a tertiary adjustment force in accordance with response time (Non-patent Document 1).

The tertiary adjustment force is an adjustment force in which the response time is 15 minutes, or 45 minutes or less. The procurement of tertiary adjustment forces (2) having a response time of 45 minutes started in 2021. The secondary adjustment force is an adjustment force in which the response time is 5 minutes or less, and the primary adjustment force is an adjustment force in which a response time is 10 seconds or less.

The procurement start in 2024 of the secondary adjustment force and the primary adjustment force is scheduled.

### RELATED ART DOCUMENTS

### Non-Patent Documents

Non-Patent Document 1:“Trade guide (all products), Apr. 1, 2023, first edition, revised draft”, [online], [retrieved on Feb. 8, 2023], Internet <URL: https://www.tdgc.jp/j_information/docs/guide_202304rev. pdf>

### SUMMARY OF INVENTION

A control apparatus according to an aspect of the present disclosure is a control apparatus that controls charging-discharging of a vehicle group which includes a plurality of electric vehicles, the control apparatus including an acquisition portion that acquires an adjustment request amount indicating an output adjustable range which is a range in which output electric power of a charge-discharge device that performs charging-discharging of the electric vehicle is capable of being adjusted in response to a frequency variation of an electric power system, and a determination portion that determines, based on the adjustment request amount acquired by the acquisition portion, a second adjustment rate which is smaller than a first adjustment rate determined for the vehicle group as an adjustment rate used in a charge-discharge control of an electric vehicle included in the vehicle group.

### BRIEF DESCRIPTION OF DRAWINGS

FIG. 1 is a view showing an example of a charge-discharge control system according to an embodiment.

FIG. 2 is a block diagram showing an example of a hardware configuration of a control server according to the embodiment.

FIG. 3 is a functional block diagram showing an example of a function of the control server according to the embodiment.

FIG. 4 is a view for explaining selection of a target vehicle.

FIG. 5 is a graph for explaining an example of provision of a primary adjustment force in a contract vehicle group.

FIG. 6 is a graph for explaining an example of a frequency response operation in one electric vehicle when the primary adjustment force is equally divided among a plurality of electric vehicles.

FIG. 7 is a graph for explaining an example of a frequency response operation in one electric vehicle when the primary adjustment force is divided by the control server according to the embodiment.

FIG. 8 is a graph for explaining another example of a frequency response operation in one electric vehicle when the primary adjustment force is divided by the control server according to the embodiment.

FIG. 9 is a graph for explaining another example of provision of the primary adjustment force in the contract vehicle group.

FIG. 10 is a graph for explaining another example of a frequency response operation in one electric vehicle when the primary adjustment force is equally divided among a plurality of electric vehicles.

FIG. 11 is a graph for explaining still another example of a frequency response operation in one electric vehicle when the primary adjustment force is divided by the control server according to the embodiment.

FIG. 12 is a flowchart showing an example of a control process by the control server according to the embodiment.

### DESCRIPTION OF EMBODIMENTS

### Problem to Be Solved by Present Disclosure

When a vehicle (hereinafter, also referred to as an “electric vehicle”) on which a battery for traveling such as a BEV (Battery Electric Vehicle) or PHEV (Plug in Hybrid Electric Vehicle) is mounted is utilized for a frequency adjustment force, it is required to efficiently utilize a small number of electric vehicles.

### Effect of Present Disclosure

According to the present disclosure, it is possible to efficiently provide the frequency adjustment force by a small number of electric vehicles.

### Summary of Embodiment of Present Disclosure

Hereinafter, a summary of an embodiment of the present disclosure is described.

(1) A control apparatus according to the present embodiment is a control apparatus that controls charging-discharging of a vehicle group which includes a plurality of electric vehicles, the control apparatus including an acquisition portion that acquires an adjustment request amount indicating an output adjustable range which is a range in which output electric power of a charge-discharge device that performs charging-discharging of the electric vehicle is capable of being adjusted in response to a frequency variation of an electric power system, and a determination portion that determines, based on the adjustment request amount acquired by the acquisition portion, a second adjustment rate which is smaller than a first adjustment rate determined for the vehicle group as an adjustment rate used in a charge-discharge control of an electric vehicle included in the vehicle group. In the frequency adjustment force (hereinafter, also simply referred to as an “adjustment force”), a response based on an adjustment rate is required in order to provide an adjustment force in response to the frequency variation.

According to the configuration described above, by performing charging-discharging of the electric vehicle by the second adjustment rate, it is possible to increase a charge amount and a discharge amount of the electric vehicle as compared with the case where charging-discharging of the electric vehicle is performed by the first adjustment rate.

Therefore, it is possible to efficiently provide the adjustment force by a small number of vehicles.
(2) In (1) described above, the second adjustment rate may be an adjustment rate for setting the output electric power of the charge-discharge device to a limit value of the adjustment request amount when a frequency of the electric power system changes to a specific frequency. Thereby, it is possible to perform charging-discharging of the electric vehicle to the limit value of the adjustment request amount in a frequency range defined by the specific frequency.
(3) In (2) described above, the specific frequency may be a limit value of a frequency adjustment range of the charge-discharge device when the charge-discharge device performs a frequency response operation by the first adjustment rate in an output electric power adjustment range determined for the vehicle group. Thereby, it is possible to perform charging-discharging of the electric vehicle to the limit value of the adjustment request amount in the frequency adjustment range.
(4) In (2) or (3) described above, the limit value of the adjustment request amount may be rated output electric power of the charge-discharge device. Thereby, it is possible to perform charging-discharging of the electric vehicle up to the rated output electric power of the charge-discharge device.
(5) In any one of (1) to (3) described above, the determination portion may determine the second adjustment rate within a range defined by the first adjustment rate and a predetermined lower limit value of the second adjustment rate. Thereby, it is possible to determine the second adjustment rate within an appropriate range.
(6) In (5) described above, the determination portion may determine the second adjustment rate to be the lower limit value. Thereby, it is possible to increase the range of the output electric power of the charge-discharge device.
(7) In (6) described above, the determination portion may determine a control limit value of the output electric power of the charge-discharge device that is different from rated output electric power of the charge-discharge device. Thereby, it is possible to efficiently perform charging-discharging of the electric vehicle in a range defined by the control limit value.
(8) In (7) described above, the control limit value may be an output electric power value of the charge-discharge device corresponding to a specific frequency when the charge-discharge device performs a frequency response operation by the second adjustment rate. Thereby, it is possible to determine the control limit value for efficiently performing charging-discharging of the electric vehicle on the basis of the specific frequency.
(9) In (8) described above, the specific frequency may be a limit value of a frequency adjustment range of the charge-discharge device when the charge-discharge device performs a frequency response operation by the first adjustment rate in an output electric power adjustment range determined for the vehicle group. Thereby, it is possible to determine the control limit value for efficiently performing charging-discharging of the electric vehicle in the frequency adjustment range.
(10) In any one of (1) to (9) described above, the control apparatus may further include a selection portion that selects a target vehicle which is an electric vehicle as a target of a charge-discharge control by the second adjustment rate, based on an output electric power adjustment range determined for the vehicle group and the adjustment request amount of each of the plurality of electric vehicles included in the vehicle group. Thereby, it is possible to select the target vehicle used for provision of the adjustment force.
(11) In (10) described above, the selection portion may select the target vehicle such that a sum of the adjustment request amount of the plurality of target vehicles satisfies a condition based on the output electric power adjustment range. Thereby, it is possible to appropriately set the number of the target vehicles on the basis of the output electric power adjustment range.
(12) A control method according to the present embodiment is a control method that controls charging-discharging of a vehicle group which includes a plurality of electric vehicles, the control method including a step of acquiring an adjustment request amount indicating an output adjustable range which is a range in which output electric power of a charge-discharge device that performs charging-discharging of the electric vehicle is capable of being adjusted in response to a frequency variation of an electric power system, and a step of determining, based on the acquired adjustment request amount, a second adjustment rate which is smaller than a first adjustment rate determined for the vehicle group as an adjustment rate used in a charging-discharging control of an electric vehicle included in the vehicle group. Thereby, charging-discharging of the electric vehicle is performed by the second adjustment rate, and thereby, it is possible to increase a charge amount and a discharge amount of the electric vehicle as compared with the case where charging-discharging of the electric vehicle is performed by the first adjustment rate. Therefore, it is possible to efficiently provide the adjustment force by a small number of vehicles.
(13) A control program according to the present embodiment is a control program for controlling charging-discharging of a vehicle group which includes a plurality of electric vehicles, the control program causing a computer to execute a step of acquiring an adjustment request amount indicating an output adjustable range which is a range in which output electric power of a charge-discharge device that performs charging-discharging of the electric vehicle is capable of being adjusted in response to a frequency variation of an electric power system, and a step of determining, based on the acquired adjustment request amount, a second adjustment rate which is smaller than a first adjustment rate determined for the vehicle group as an adjustment rate used in a charging-discharging control of an electric vehicle included in the vehicle group. Thereby, charging-discharging of the electric vehicle is performed by the second adjustment rate, and thereby, it is possible to increase a charge amount and a discharge amount of the electric vehicle as compared with the case where charging-discharging of the electric vehicle is performed by the first adjustment rate. Therefore, it is possible to efficiently provide the adjustment force by a small number of vehicles.

The present disclosure can be realized as a control apparatus that includes the characteristic configuration as described above, a control method in which the characteristic process as described above is a step, and a control program for causing a computer to execute the characteristic process and can also be realized as a charge-discharge control system that includes the control apparatus or be realized as a semiconductor integrated circuit that realizes part of or all of the control apparatus.

### Details of Embodiment of Present Disclosure

Hereinafter, details of an embodiment of the present invention will be described with reference to the drawings. At least part of the embodiment described below may be arbitrarily combined.

### 1. Charge-Discharge Control System

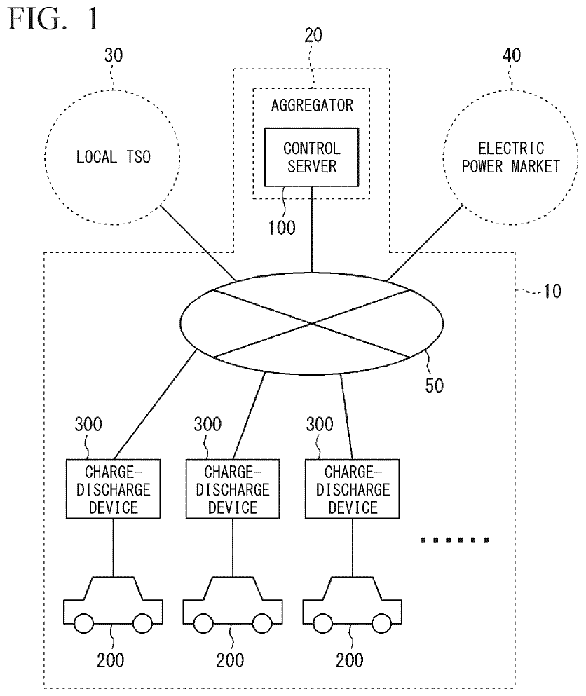

FIG. 1 is a view showing an example of a charge-discharge control system according to the embodiment.

A charge-discharge control system 10 includes a control server 100, a plurality of electric vehicles 200, and a plurality of charge-discharge devices 300.

The electric vehicle 200 is owned by a customer (for example, an individual person or a corporation) of electric power. In the present embodiment, the electric vehicle 200 is used as an energy resource for a primary adjustment force as an example of a frequency adjustment force.

The charge-discharge device 300 performs charging-discharging (of a battery) of the electric vehicle 200. Specifically, the charge-discharge device 300 is connected to an electric power system (not shown) operated and managed by a local TSO (Transmission System Operator) 30, and charges the electric vehicle 200 by a forward flow of electric power from the electric power system, or generates a reverse flow of electric power to the electric power system by discharging the electric vehicle 200. The local TSO 30 is a general electricity transmission and distribution business operator in an area where the house of the customer or the like is located. The charge-discharge device 300 is, for example, an off-board charger that is not mounted on the electric vehicle 200. As another example, the charge-discharge device 300 may be an on-board charger that is mounted on the electric vehicle 200.

The charge-discharge device 300 has a communication function. Specifically, the charge-discharge device 300 includes a wired communication interface or a wireless communication interface and is connected to the Internet 50 by wired communication or wireless communication.

The control server 100 is connected to the Internet 50. The control server 100 can communicate with the charge-discharge device 300 via the Internet 50.

The control server 100 is operated and managed by an aggregator 20. The aggregator 20 is a business operator that integrally controls the electric vehicle 200 (and the charge-discharge device 300) which is a distributed energy resource and conducts electricity trading with an electric power market 40 by a virtual power plant (VPP) or a demand response (DR). The aggregator 20 provides a primary adjustment force to the local TSO 30 by causing the electric vehicle 200 to perform charging-discharging. The aggregator 20 concludes a contract of a service (hereinafter, also referred to as a “primary adjustment force provision service”) for using the electric vehicle 200 for provision of the primary adjustment force with a customer who owns the electric vehicle 200.

The aggregator 20 determines an adjustment rate (first adjustment rate) for providing the primary adjustment force in advance. The aggregator 20 bids provision of the primary adjustment force by the first adjustment rate to the electric power market 40. In the bid, a range (an upper limit and a lower limit) of electric power to be provided in a period (provision period) in which the primary adjustment force is provided is specified. The bid is contracted, and thereby, the range (contract amount) of electric power to be provided is fixed. In other words, the contract amount is a range of charging-discharging electric power in the entire vehicle group constituted by the electric vehicles 200 of all the customers who have concluded the contract with the aggregator 20.

When the bid is contracted, the control server 100 receives information (hereinafter, also referred to as “contract information”) relating to the contract from a server (not shown) operated by the electric power market 40. The contract information includes a provision period and the contract amount.

The control server 100 is an example of a “control apparatus”. The control server 100 determines a second adjustment rate by using the received contract information. The second adjustment rate is an adjustment rate used for a charge-discharge control by each charge-discharge device 300. Further, the control server 100 selects the electric vehicle 200 which is a target of the charge-discharge control by the second adjustment rate from a vehicle group (hereinafter, also referred to as a “contract vehicle group”) constituted of all the electric vehicles 200 owned by customers who have contracted the primary adjustment force provision service with the aggregator 20.

Hereinafter, the selected electric vehicle 200 is also referred to as a “target vehicle”, and a vehicle group constituted of the target vehicles is also referred to as a “target vehicle group”.

The control server 100 commands each charge-discharge device 300 corresponding to the target vehicle group to perform charging-discharging that uses the second adjustment rate.

The charge-discharge device 300 includes a frequency sensor that detects a frequency (system frequency) of the electric power system. The charge-discharge device 300 that receives the command of charging-discharging performs charging-discharging of the electric vehicle 200 by the second adjustment rate based on the detected system frequency during a provision period. Thereby, a primary adjustment force is provided to the electric power system.

For example, when the provision period is ended, each charge-discharge device 300 corresponding to the target vehicle group transmits a result (a charging-discharging electric power performance and a frequency) of the performed charge-discharge control to the control server 100. The control server 100 sums up the results of the charge-discharge control that are received from the charge-discharge devices 300 and transmits the sum to a server (not shown) operated by the local TSO 30.

### 2. Hardware Configuration of Control Server

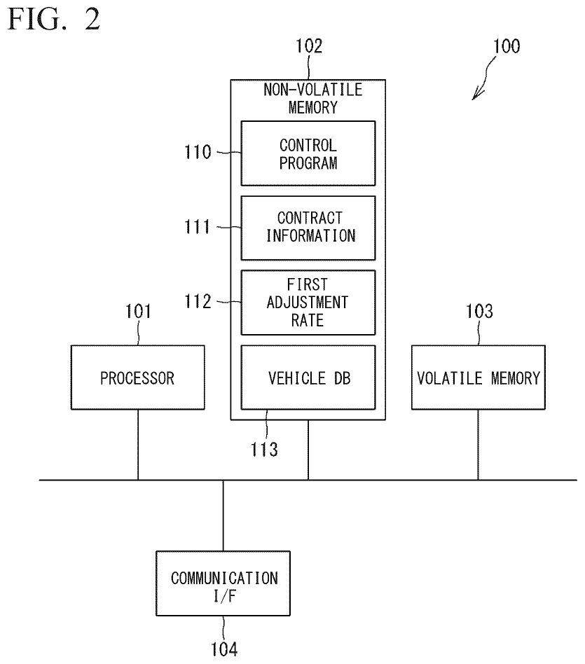

FIG. 2 is a block diagram showing an example of a hardware configuration of the control server according to the embodiment. The control server 100 includes a processor 101, a non-volatile memory 102, a volatile memory 103, and a communication interface 104.

The volatile memory 103 is, for example, a semiconductor memory such as a SRAM (Static Random Access Memory) or a DRAM (Dynamic Random Access Memory). The non-volatile memory 102 is, for example, a flash memory, a hard disk, a ROM (Read Only Memory), or the like. A control program 110 which is a computer program and data used for executing the control program 110 are stored in the non-volatile memory 102. The control program 110 is executed by the processor 101, and thereby, each function of the control server 100 is realized. The control program 110 can be stored in a recording medium such as a flash memory, a ROM, or a CD-ROM. The processor 101 can determine the second adjustment rate by the control program 110.

The processor 101 is, for example, a CPU (Central Processing Unit). However, the processor 101 is not limited to a CPU. The processor 101 may be a GPU (Graphics Processing Unit). The processor 101 is, for example, a multi-core processor. The processor 101 may be a single core processor. The processor 101 may be, for example, an ASIC (Application Specific Integrated Circuit) or may be a programmable logic device such as a gate array or an FPGA (Field Programmable Gate Array). In this case, the ASIC or the programmable logic device is constituted to be capable of executing the same process as the control program 110.

The communication interface 104 is, for example, an Ethernet interface (“Ethernet” is a registered trademark). The communication interface 104 is connected to the Internet 50. The communication interface 104 can transmit and receive, for example, a packet of the TCP/IP (Transmission Control Protocol/Internet Protocol).

Contract information 111 received from the electric power market 40 is stored in the non-volatile memory 102. A predetermined first adjustment rate 112 is stored in the non-volatile memory 102.

The non-volatile memory 102 has a vehicle database (hereinafter, also referred to as a “vehicle DB”) 113. Information (hereinafter, also referred to as “contract vehicle information”) of all the electric vehicles 200 owned by the customers who have concluded the contract of the primary adjustment force provision service with the aggregator 20 is stored in the vehicle DB 113. In a specific example, the contract vehicle information includes a vehicle ID of the electric vehicle 200 and rated output electric power (an upper limit value, that is, rated discharge electric power and a lower limit value, that is, rated charge electric power) of the charge-discharge device 300.

The control server 100 may be a dedicated server for controlling the charge-discharge device 300 of the contract vehicle group and providing the adjustment force, or may be used as a server for providing a service different from the provision of the adjustment force. For example, the control server 100 may be a cloud server.

### 3. Function of Control Server

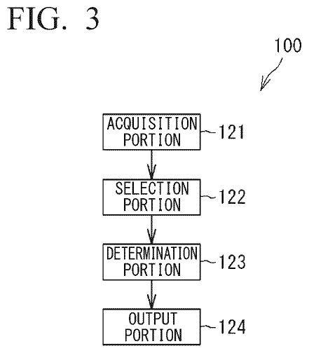

FIG. 3 is a functional block diagram showing an example of a function of the control server according to the embodiment.

The processor 101 executes the control program 110, and thereby, the control server 100 executes each function of an acquisition portion 121, a selection portion 122, a determination portion 123, and an output portion 124.

The acquisition portion 121 acquires an adjustment request amount indicating an output adjustable range which is a range in which output electric power of the charge-discharge device 300 is capable of being adjusted in response to a frequency variation of the electric power system. The adjustment request amount is a range defined by a limit value (upper limit value) of discharge electric power of the charge-discharge device 300 and a limit value (lower limit value) of charge electric power. An example of the limit value of the adjustment request amount is the rated output electric power of the charge-discharge device 300. That is, an example of the upper limit value of the adjustment request amount is the rated discharge electric power of the charge-discharge device 300, and an example of the lower limit value of the adjustment request amount is the rated charge electric power of the charge-discharge device 300. The acquisition portion 121 can acquire the rated output electric power of the charge-discharge device 300 with reference to the vehicle DB 113.

For example, the acquisition portion 121 receives the contract information 111 transmitted from the electric power market 40 and thereby acquires the contract information 111. The contract information 111 is stored in the non-volatile memory 102.

The selection portion 122 selects a target vehicle from the contract vehicle group on the basis of the output electric power adjustment range determined for the contract vehicle group and the adjustment request amount acquired by the acquisition portion 121. The contract amount is an example of the output electric power adjustment range determined for the contract vehicle group.

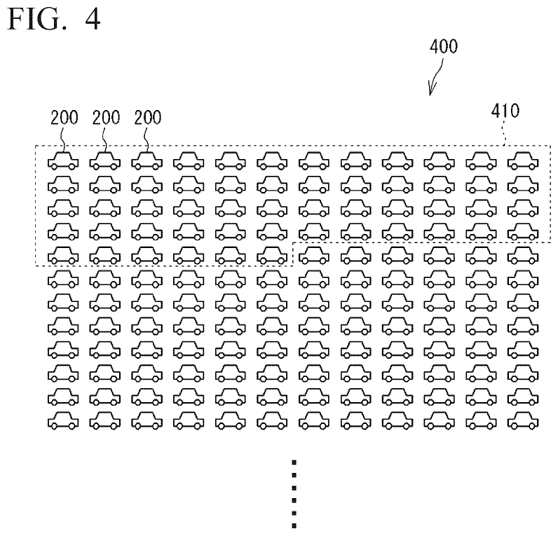

FIG. 4 is a view for explaining selection of a target vehicle. In the entire contract vehicle group 400, it is required to adjust the charging-discharging electric power in a range (output electric power adjustment range) defined by the contract amount in response to the variation of the system frequency in the provision period. The selection portion 122 selects a target vehicle and determines a target vehicle group 410 which is a subset of the contract vehicle group 400. In the following description, the contract amount is referred to as “PE1”, and the rated output electric power of the entire contract vehicle group 400, that is, the sum of the rated output electric power of all the electric vehicles 200 included in the contract vehicle group 400 is referred to as “PE2”.

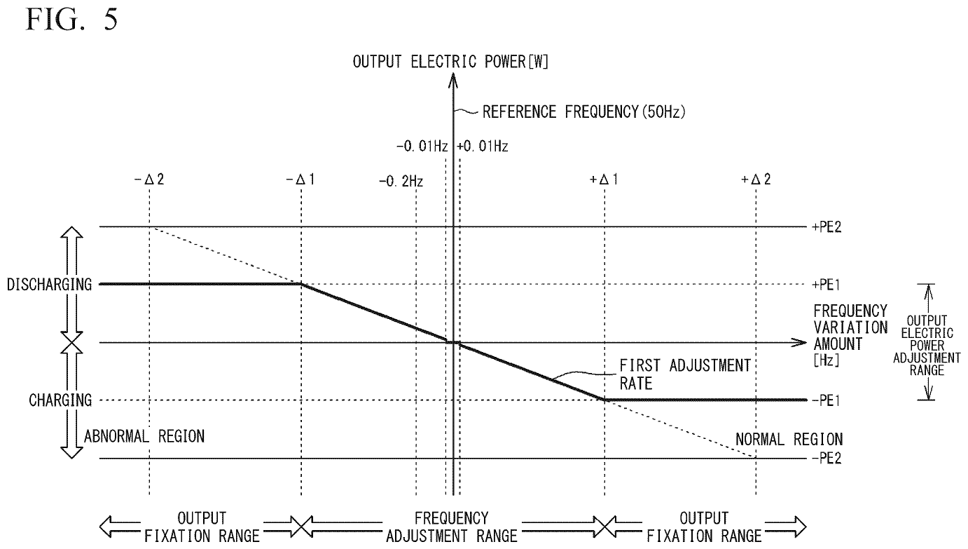

FIG. 5 is a graph for explaining an example of provision of the primary adjustment force in the contract vehicle group. In FIG. 5, the horizontal axis represents a frequency variation amount [Hz], and the vertical axis represents output electric power [W] of the entire contract vehicle group. As described above, the contract vehicle group 400 is required to perform a response operation to the system frequency in the output electric power adjustment range in the provision period. A frequency response operation of the output electric power in the entire contract vehicle group 400 is in accordance with the first adjustment rate. The first adjustment rate is set to 5% or less.

The adjustment rate is represented by a straight line in an orthogonal coordinate system of the frequency variation amount and the output electric power. In the example of FIG. 5, the response operation in accordance with the first adjustment rate is represented as a straight line that connects a point (−Δ1, +PE1) to a point (+Δ1, −PE1).

In the drawing, a frequency variation range of equal to or more than −0.01 Hz and equal to or less than +0.01 Hz is a dead zone. In the dead zone, the frequency response operation is not performed.

In the drawing, the frequency variation range of equal to or less than −0.2 Hz is an abnormal region. That is, when the system frequency is decreased to be lower than the reference frequency by 0.2 Hz or more, the electric power system is in an abnormal state. For example, when a large-scale electric power outage occurs, when the electric power generation amount of part of electric power plants becomes zero, or the like, the system frequency may significantly decreases and enter an abnormal region. A frequency variation range of more than −0.2 Hz is a normal region. That is, when the deviation of the system frequency from the reference frequency is more than −0.2 Hz, the electric power system is in a normal state.

When the system frequency increases from the reference frequency, the output electric power (charge electric power) corresponding to the deviation of the system frequency from the reference frequency is determined by the first adjustment rate, and the entire contract vehicle group 400 performs charging corresponding to the output electric power. In this case, electric power is supplied from the electric power system to the contract vehicle group 400 (forward flow). Accordingly, the output electric power from the contract vehicle group 400 is negative.

In the first adjustment rate, when the deviation of the system frequency from the reference frequency is +Δ1, the output electric power of the contract vehicle group 400 reaches −PE1. The rated charge electric power (−PE2) of the entire contract vehicle group 400 is smaller than −PE1. That is, the contract vehicle group 400 can still be charged even when the charge electric power exceeds −PE1. However, in the provision of the primary adjustment force, the charge electric power of the entire contract vehicle group 400 does not exceed −PE1. That is, when the deviation exceeds +Δ1, the output electric power of the entire contract vehicle group 400 is controlled so as to maintain −PE1. A range in which the frequency variation is larger than +Δ1 is an output fixation range in which the output electric power of the entire contract vehicle group 400 is fixed to −PE1.

When the system frequency decreases from the reference frequency, the output electric power (discharge electric power) corresponding to the deviation of the system frequency from the reference frequency is determined by the first adjustment rate, and the entire contract vehicle group 400 performs discharging corresponding to the output electric power. In this case, electric power is supplied from the contract vehicle group 400 to the electric power system (reverse flow). Accordingly, the output electric power from the contract vehicle group 400 is positive.

In the first adjustment rate, when the deviation of the system frequency from the reference frequency is −Δ1, the output electric power of the contract vehicle group 400 reaches +PE1. The rated discharge electric power (+PE2) of the entire contract vehicle group 400 is larger than +PE1. That is, the contract vehicle group 400 can still be discharged even when the discharge electric power exceeds +PE1. However, in the provision of the primary adjustment force, the discharge electric power of the entire contract vehicle group 400 does not exceed +PE1. That is, when the deviation exceeds −Δ1, the output electric power of the entire contract vehicle group 400 is controlled so as to maintain +PE1. A range in which the frequency variation is smaller than −Δ1 is an output fixation range in which the output electric power of the entire contract vehicle group 400 is fixed to +PE1. A range in which the frequency variation is equal to or more than −Δ1 and equal to or less than Al is a frequency adjustment range in which the output electric power of the entire contract vehicle group 400 is adjusted in a range from +PE1 to −PE1.

The control server 100 commands each charge-discharge device 300 to perform the charging-discharging so that the entire contract vehicle group 400 performs a frequency response operation in accordance with the first adjustment rate as described above. For example, it is considered that the electric power (that is, the primary adjustment force) that is output by each electric vehicle 200 is equally divided among the plurality of electric vehicles 200. At this time, the number N of the electric vehicles 200 as a target of the charging-discharging is determined so that the upper limit value of the output electric power of the charge-discharge device 300 is not larger than the rated discharge electric power, and the lower limit value of the output electric power of the charge-discharge device 300 is not smaller than the rated charge electric power.

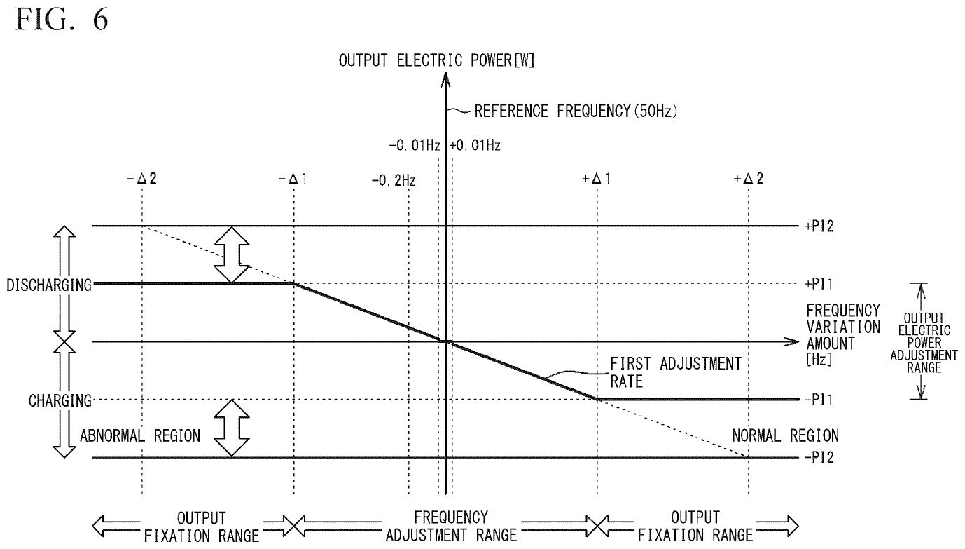

FIG. 6 is a graph for explaining an example of a frequency response operation in one electric vehicle when the primary adjustment force is equally divided among a plurality of electric vehicles. In FIG. 6, the horizontal axis represents a frequency variation amount [Hz], and the vertical axis represents output electric power [W] of the charge-discharge device 300 corresponding to one electric vehicle 200. In this case, the range of the output electric power of each electric vehicle 200 is a value obtained by dividing the contract amount by the number N of the target electric vehicles 200. That is, an upper limit value PI1 and a lower limit value −PI1 of the output electric power adjustment range of one electric vehicle 200 are determined by PI1=PE1÷N.

A charge-discharge device 300 connected to an electric vehicle 200 as a target used for provision of the primary adjustment force performs charging-discharging in response to the variation of the system frequency in accordance with the first adjustment rate. In the example of FIG. 6, it is assumed that the same adjustment rate as the first adjustment rate used in the entire contract vehicle group 400 is used for an individual charge-discharge device 300. In the example of FIG. 6, the response operation in accordance with the first adjustment rate is represented as a straight line that connects a point (−Δ1, +PI1) to a point (+Δ1, −PI1).

When the system frequency increases from the reference frequency, the output electric power (charge electric power) corresponding to the deviation of the system frequency from the reference frequency is determined by the first adjustment rate, and each of the charge-discharge devices 300 performs charging corresponding to the output electric power.

In the first adjustment rate, when the deviation of the system frequency from the reference frequency is +Δ1, the output electric power of one charge-discharge device 300 reaches −PI1. The rated charge electric power (−PI2) of the charge-discharge device 300 is smaller than −PI1. That is, each charge-discharge device 300 can still be charged even when the charge electric power exceeds −PI1. However, so that the charge electric power of the entire contract vehicle group 400 does not exceed −PE1, it is required that the charge electric power of each charge-discharge device 300 does not exceed −PI1.

That is, when the deviation exceeds +Δ1, the output electric power of the charge-discharge device 300 is controlled so as to maintain −PI1. A range in which the frequency variation is larger than +Δ1 is an output fixation range in which the output electric power of the charge-discharge device 300 is fixed to −PI1.

When the system frequency decreases from the reference frequency, the output electric power (discharge electric power) corresponding to the deviation of the system frequency from the reference frequency is determined by the first adjustment rate, and each of the charge-discharge devices 300 performs discharging corresponding to the output electric power.

In the first adjustment rate, when the deviation of the system frequency from the reference frequency is Δ1, the output electric power of one charge-discharge device 300 reaches +PI1. The rated discharge electric power (+PI2) of the charge-discharge device 300 is larger than +PI1. That is, each charge-discharge device 300 can still be discharged even when the discharge electric power exceeds +PI1. However, in order that the discharge electric power of the entire contract vehicle group 400 does not exceed +PE1, it is necessary that the discharge electric power of each charge-discharge device 300 does not exceed +PI1. That is, when the deviation exceeds −Δ1, the output electric power of the charge-discharge device 300 is controlled so as to maintain +PI1. The range in which the frequency variation is smaller than −Δ1 is an output fixation range in which the output electric power of the charge-discharge device 300 is fixed to +PI1.

The range in which the frequency variation is equal to or more than −Δ1 and equal to or less than Δ1 is a frequency adjustment range in which the output electric power of the charge-discharge device 300 is adjusted in a range from +PI1 to −PI1.

In such a charge-discharge control, an output (discharge) of the electric power that exceeds +PI1 is restricted, and an output (charge) of the electric power that exceeds −PI1 is restricted. That is, efficient charging-discharging by the charge-discharge device 300 cannot be performed.

The control server 100 according to the present embodiment performs efficient charging-discharging by each charge-discharge device 300 and provides the primary adjustment force. That is, the control server 100 enlarges the output electric power adjustment range of the charge-discharge device 300 for providing the primary adjustment force.

In the example of FIG. 6, when it is assumed that the output of the charge-discharge device 300 is decreased to the rated value −PI2 in accordance with the first adjustment rate, the output electric power reaches −PI2 when the frequency deviation is +Δ2. When it is assumed that the output of the charge-discharge device 300 is increased to the rated value +PI2 in accordance with the first adjustment rate, the output electric power reaches +PI2 when the frequency deviation is−Δ2.

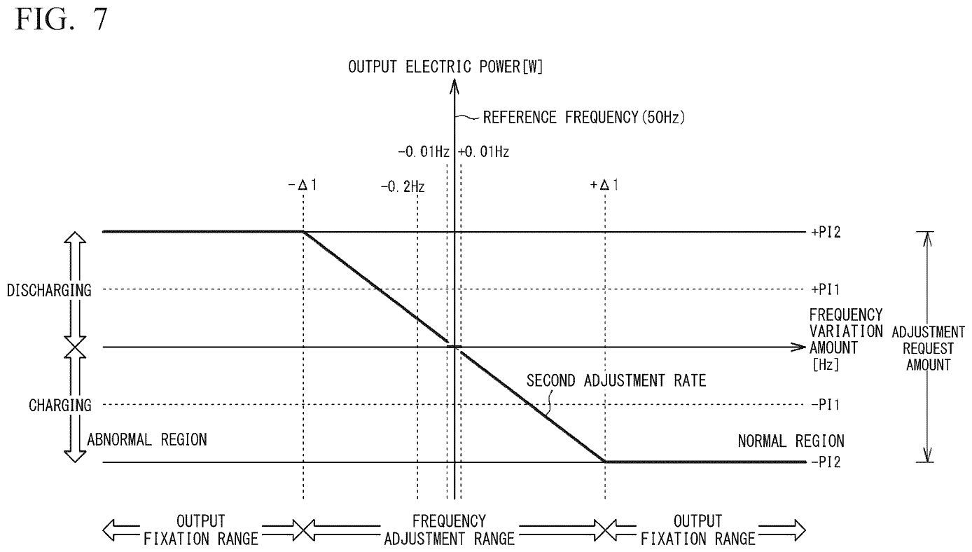

FIG. 7 is a graph for explaining an example of a frequency response operation in one electric vehicle when the primary adjustment force is divided by the control server according to the embodiment. In FIG. 7, the horizontal axis represents a frequency variation amount [Hz], and the vertical axis represents output electric power [W] of the charge-discharge device 300 corresponding to one electric vehicle 200.

The control server 100 determines, for example, a second adjustment rate in which the upper limit value of the output electric power adjustment range is +PI2, and the lower limit value is −PI2.

In the example of FIG. 7, when it is assumed that the output of the charge-discharge device 300 is decreased to the rated value −PI2 in accordance with the second adjustment rate, the output electric power reaches −PI2 when the frequency deviation is +Δ1. When it is assumed that the output of the charge-discharge device 300 is increased to the rated value +PI2 in accordance with the second adjustment rate, the output electric power reaches +PI2 when the frequency deviation is −Δ1. That is, the charge-discharge device 300 can perform a frequency response operation in the range of the rated output electric power. Accordingly, it is possible to efficiently use the charge-discharge device 300 and provide the primary adjustment force.

With reference back to FIG. 3, the selection portion 122 selects a target vehicle from the contract vehicle group 400 so that the sum of the adjustment request amounts of the target vehicles satisfies a condition based on the output electric power adjustment range determined for the contract vehicle group. In a specific example, the selection portion 122 selects a target vehicle from the contract vehicle group 400 such that the sum of the rated output electric power of the target vehicle is equal to or more than the contract amount. That is, the condition in this case is that the sum of the rated output electric power of the target vehicle is equal to or more than the contract amount. The rated output electric power of each charge-discharge device 300 may be different from each other. That is, the rated output electric power of a charge-discharge device A may be different from the rated output electric power of a charge-discharge device B. For example, the selection portion 122 can select a target vehicle such that the sum of the rated output electric power of each charge-discharge device 300 connected to a target vehicle included in a target vehicle group 410 matches the contract amount.

When the sum of the rated output electric power of each charge-discharge device 300 connected to the target vehicle matches the contract amount, each charge-discharge device 300 can perform charging-discharging of the electric vehicle 200 in the range of the rated output electric power in response to the variation of the system frequency. The determination portion 123 determines, as an adjustment rate used in the charge-discharge control of the target vehicle, a second adjustment rate that is smaller than the first adjustment rate on the basis of the adjustment request amount acquired by the acquisition portion 121. In a specific example, the determination portion 123 can determine the second adjustment rate on the basis of the first adjustment rate, the contract amount PE1, and the rated output electric power PE2 of the entire contract vehicle group 400. That is, the determination portion 123 determines a frequency (specific frequency) at which the output electric power of the entire contract vehicle group 400 reaches the contract amount from the first adjustment rate and the contract amount PE1. Further, the determination portion 123 obtains an adjustment rate that becomes the rated output electric power PE2 at the specific frequency and determines this adjustment rate as the second adjustment rate. That is, the second adjustment rate is an adjustment rate in which the upper limit value of the output electric power adjustment range of the entire contract vehicle group 400 is +PE2, and the lower limit value is −PE2. The rated output electric power PE2 is the sum of the rated output electric power of the charge-discharge devices 300 used for charging-discharging of the electric vehicles 200 included in the contract vehicle group 400 and is, for example, the sum of the rated output electric power of the charge-discharge devices 300 used for charging-discharging of the electric vehicles 200 included in the target vehicle group 410. That is, the determination portion 123 determines the second adjustment rate on the basis of the sum of the adjustment request amounts of the charge-discharge devices 300. In other words, the determination portion 123 determines the second adjustment rate on the basis of the rated output electric power (adjustment request amount) of each charge-discharge device 300.

For example, the second adjustment rate is an adjustment rate for setting the output electric power of the charge-discharge device 300 to the limit value of the adjustment request amount when the system frequency changes to a specific frequency. For example, the specific frequency is a limit value of the frequency adjustment range of the charge-discharge device 300 when the charge-discharge device 300 performs a frequency response operation by the first adjustment rate in the output electric power adjustment range.

FIG. 6 is referred to. In the example of FIG. 6, the output electric power adjustment range is an electric power range (PI1=PE1+N) determined from the contract amount. That is, the output electric power adjustment range in FIG. 6 corresponds to the contract amount. In the charge-discharge device 300, a range (frequency adjustment range) of a frequency in which a response operation can be performed in accordance with the first adjustment rate is a range of equal to or more than −Δ1 and equal to or less than Δ1. That is, the limit value (the upper limit value and the lower limit value) of the frequency adjustment range is +Δ1 and −Δ1. Accordingly, in the example of FIG. 6, the specific frequency is +Δ1 and −Δ1.

FIG. 7 is referred to. In the example of FIG. 7, the upper limit value of the adjustment request amount is +PI2, and the lower limit value is −PI2. The second adjustment rate is an adjustment rate in which the output electric power of the charge-discharge device 300 is −PI2 when the variation amount of the system frequency is +Δ1, and the output electric power of the charge-discharge device 300 is +PI2 when the variation amount of the system frequency is −Δ1. That is, in the example of FIG. 7, the second adjustment rate is represented as a straight line that connects a point ( Δ1, +PI2) to a point (+Δ1, −PI2). The determination portion 123 can determine the second adjustment rate as the straight line that connects the point (−Δ1, +PI2) to the point (+Δ1, −PI2).

The second adjustment rate is smaller than the first adjustment rate. That is, the second adjustment rate corresponds to a response operation that performs charging-discharging at an output which is larger than that of the first adjustment rate in an identical frequency variation. Accordingly, the individual charge-discharge device 300 can output electric power within the adjustment request amount defined by PI2 and −PI2 beyond PI1 and −PI1 described above by performing a frequency response operation in accordance with the second adjustment rate. Therefore, the primary adjustment force can be provided by efficiently performing charging-discharging of each target vehicle in the range of the rated electric power.

In this case, the rated output electric power (rated discharge electric power, rated charge electric power) varies depending on the charge-discharge device 300. Since the second adjustment rate is common among the charge-discharge devices 300, when each charge-discharge device 300 performs a frequency response operation in accordance with the second adjustment rate, the output electric power from each charge-discharge device 300 becomes a magnitude corresponding to the rated output electric power of each charge-discharge device 300. That is, the output electric power from a charge-discharge device 300 having large rated output electric power is large, and the output electric power from a charge-discharge device 300 having small rated output electric power is small.

With reference back to FIG. 3, the determination portion 123 may determine the second adjustment rate for performing the frequency response operation by an adjustment request amount that is different from the range of the rated discharge electric power PI2 and the rated charge electric power −PI2. For example, the determination portion 123 can determine the second adjustment rate within a range defined by the first adjustment rate and a predetermined lower limit value of the second adjustment rate.

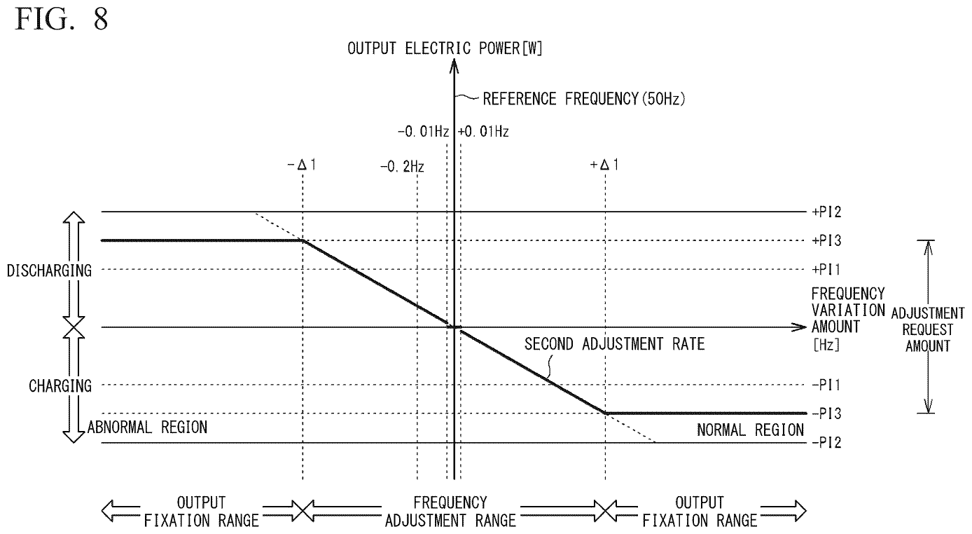

FIG. 8 is a graph for explaining another example of a frequency response operation in one electric vehicle when the primary adjustment force is divided by the control server according to the embodiment. The adjustment request amount may be a range that is larger than the output electric power adjustment range (the range of the upper limit value PI1 and the lower limit value −PI1) of the charge-discharge device 300 corresponding to the contract amount and is smaller than the range (the range of the upper limit value PI2 and the lower limit value −PI2) of the rated output electric power of the charge-discharge device 300. That is, a range in which PI3 which is larger than PI1 and is smaller than PI2 is an upper limit value, and −PI3 which is smaller than−PI1 and is larger than −PI2 is a lower limit value may be the adjustment request amount.

In the example of FIG. 8, the upper limit value of the adjustment request amount is +PI3, and the lower limit value is −PI3. The second adjustment rate is an adjustment rate in which the output electric power of the charge-discharge device 300 is −PI3 when the variation amount of the system frequency is +Δ1, and the output electric power of the charge-discharge device 300 is +PI3 when the variation amount of the system frequency is −Δ1. That is, in the example of FIG. 8, the second adjustment rate is represented as a straight line that connects a point (−Δ1, +PI3) to a point (+Δ1, −PI3). The determination portion 123 can determine the second adjustment rate as the straight line that connects the point (−Δ1, +PI3) to the point (+Δ1, −PI3).

Even in the example of FIG. 8, the second adjustment rate is smaller than the first adjustment rate. Accordingly, the individual charge-discharge device 300 can output electric power within the adjustment request amount defined by PI3 and −PI3 beyond PI1 and −PI1 described above by performing a frequency response operation in accordance with the second adjustment rate. Therefore, the primary adjustment force can be provided by efficiently performing charging-discharging of each target vehicle in the range of the rated electric power.

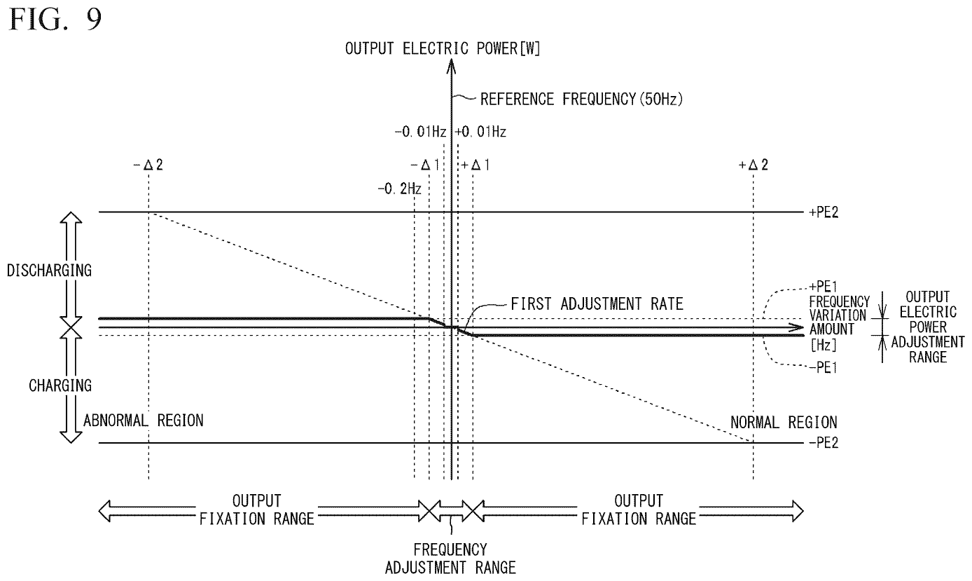

FIG. 9 is a graph for explaining another example of provision of the primary adjustment force in the contract vehicle group. In FIG. 9, the horizontal axis represents a frequency variation amount [Hz], and the vertical axis represents output electric power [W] of the entire contract vehicle group.

When the contract amount is small, the output electric power adjustment range becomes narrow. In this case, when the frequency response operation is performed in accordance with the first adjustment rate, the output electric power reaches the lower limit value −PE1 only by the frequency slightly increasing, and the output electric power reaches the upper limit value +PE1 only by the frequency slightly decreasing. That is, the frequency adjustment range defined by +Δ1 and −Δ1 is small.

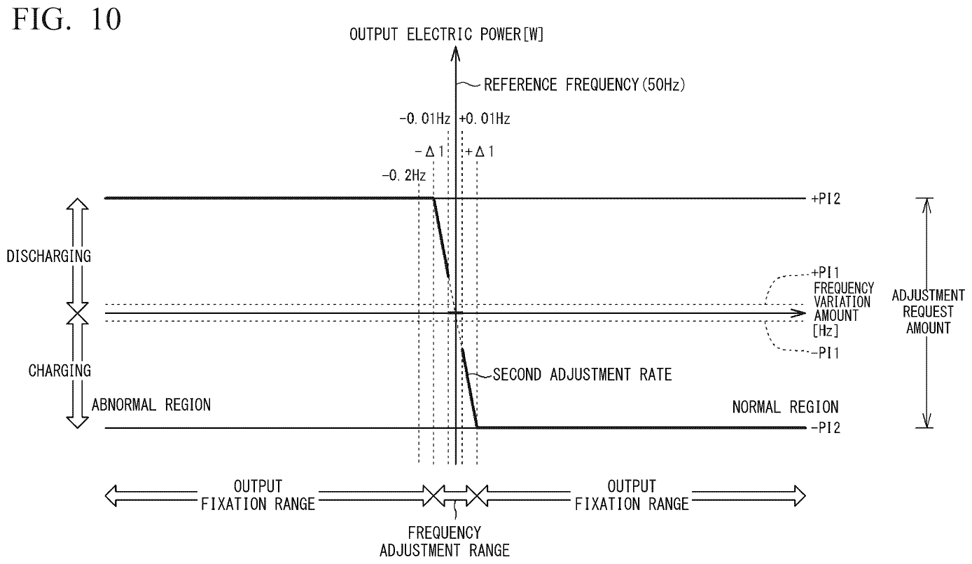

FIG. 10 is a graph for explaining another example of a frequency response operation in one electric vehicle when the primary adjustment force is equally divided among a plurality of electric vehicles. In FIG. 10, the horizontal axis represents a frequency variation amount [Hz], and the vertical axis represents output electric power [W] of the charge-discharge device 300 corresponding to one electric vehicle 200. In this case, the upper limit value PI1 and the lower limit value−PI1 of the output electric power adjustment range of one electric vehicle 200 are determined by PI1=PE1+N.

As described above, in the example of FIG. 10, the frequency adjustment range defined by +Δ1 and −Δ1 is small. Therefore, only by the system frequency slightly increasing from the reference frequency (frequency variation amount +Δ1), the output electric power of the charge-discharge device 300 reaches the rated charge electric power −PI2, and only by the system frequency slightly decreasing from the reference frequency (frequency variation amount −Δ1), the output electric power of the charge-discharge device 300 reaches the rated discharge electric power +PI2. That is, it is necessary to change the output electric power sensitively in response to the variation amount of the frequency, and it becomes difficult to cause the output electric power of the charge-discharge device 300 to follow the frequency variation.

FIG. 3 is referred to again. As described above, the determination portion 123 may determine the second adjustment rate within a range defined by the first adjustment rate and a lower limit value of the second adjustment rate. In this case, the first adjustment rate is an upper limit value of the second adjustment rate. The lower limit value can be determined from the viewpoint of feasibility of the charge-discharge control by the charge-discharge device 300. That is, the smallest value among adjustment rates that can cause the output electric power of the charge-discharge device 300 to follow the frequency variation can be set as the lower limit value of the second adjustment rate.

The determination portion 123 can determine the second adjustment rate as the lower limit value.

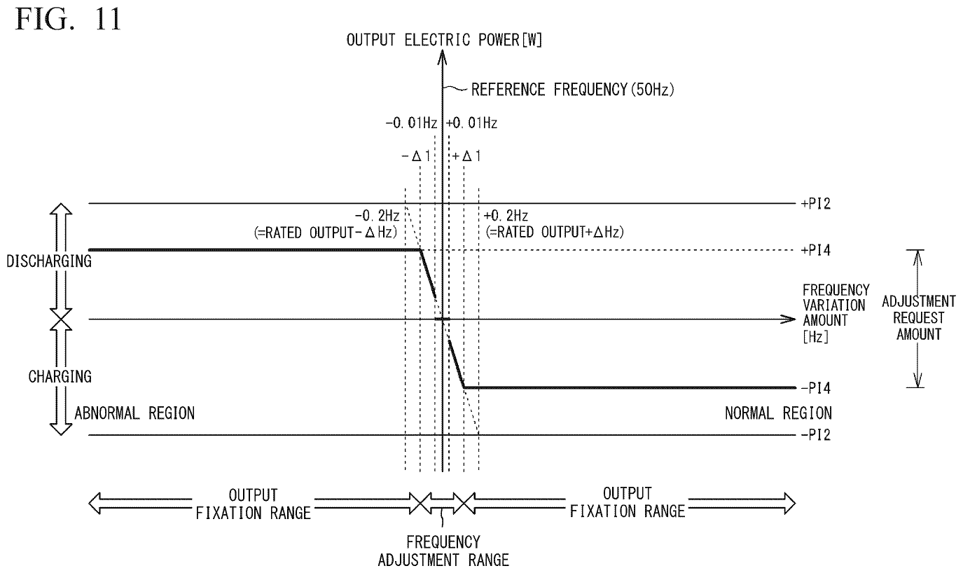

FIG. 11 is a graph for explaining still another example of a frequency response operation in one electric vehicle when the primary adjustment force is divided by the control server according to the embodiment. In FIG. 11, a second adjustment rate determined as the lower limit value is shown. In the second adjustment rate shown in FIG. 11, the output electric power when the frequency variation amount is −0.2 Hz is PI2, and the output electric power when the frequency variation amount is +0.2 Hz is −PI2. That is, this second adjustment rate is a straight line that connects a point (−0.2 Hz, +PI2) and a point (+0.2 Hz, −PI2).

With reference back to FIG. 3, the determination portion 123 can determine a control limit value of the output electric power of the charge-discharge device 300 that is different from the rated output electric power of the charge-discharge device 300. The control limit value includes a control upper limit value and a control lower limit value. The control limit value is, for example, an output electric power value of the charge-discharge device 300 corresponding to a specific frequency when the charge-discharge device 300 performs a frequency response operation by the second adjustment rate.

That is, in the example of FIG. 11, the control upper limit value is an output electric power value +PI4 of the charge-discharge device 300 corresponding to −Δ1 when the charge-discharge device 300 performs the frequency response operation by the second adjustment rate, and the control lower limit value is an output electric power value −PI4 of the charge-discharge device 300 corresponding to +Δ1. In the second adjustment rate of FIG. 11, the frequency variation amount −Δ1 corresponds to the control upper limit value +PI4 that is smaller than the rated discharge electric power +PI2. Similarly, the frequency variation amount +Δ1 corresponds to the control upper limit value −PI4 that is larger than the rated charge electric power −PI2. Accordingly, the adjustment request amount is a range defined by the control upper limit value +PI4 and the control lower limit value −PI4.

The control upper limit value +PI4 is smaller than the rated discharge electric power +PI2, and the control upper limit value −PI4 is larger than the rated charge electric power −PI2. Accordingly, in this second adjustment rate, it is not possible to use all of the rated output electric power of the charge-discharge device 300. However, since the second adjustment rate corresponds to a response operation that performs charging-discharging at an output which is smaller than the second adjustment rate shown in FIG. 10 in the identical frequency variation, the follow-up property of the output electric power to the frequency variation is improved. Accordingly, the charge-discharge device 300 can accurately perform the response operation to the system frequency.

With reference back to FIG. 3, the output portion 124 outputs a command of a charge-discharge control by the second adjustment rate determined by the determination portion 123. For example, the output portion 124 can transmit a charge-discharge control command to the charge-discharge device 300. The charge-discharge control command is transmitted to the charge-discharge device 300 connected to a target vehicle selected by the selection portion. The charge-discharge control command includes information of a second adjustment rate, a provision period, and an adjustment request amount.

When the provision period comes, the charge-discharge device 300 starts a charge-discharge control by a frequency response operation using the second adjustment rate. That is, the charge-discharge device 300 detects the system frequency and performs charging-discharging of the electric vehicle 200 with output electric power corresponding to the system frequency at the second adjustment rate. When the provision period ends, the charge-discharge device 300 ends the charging-discharging of the electric vehicle 200 by the the frequency response operation.

### 4. Operation of Charge-Discharge Control System

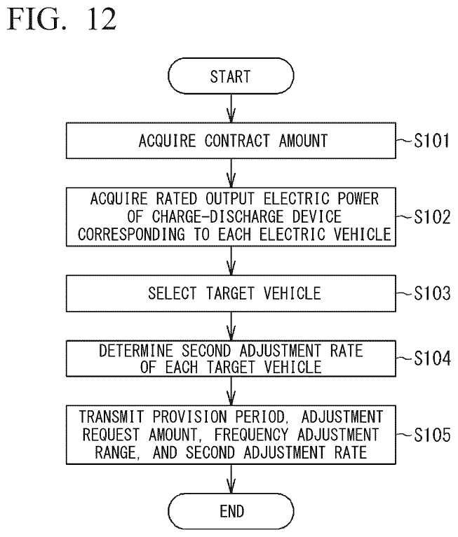

The processor 101 of the control server 100 executes the control program 110, and thereby, the control server 100 can execute the following control process. FIG. 12 is a flowchart showing an example of a control process by the control server according to the embodiment.

The aggregator 20 bids to the electric power market 40. When the bid is contracted, contract information is transmitted from the electric power market 40, and the control server 100 receives the contract information 111. The processor 101 acquires a contract amount included in the contract information 111 (Step S101).

The processor 101 acquires the rated output electric power (rated discharge electric power and rated charge electric power) of the charge-discharge device 300 corresponding to each electric vehicle 200 included in the contract vehicle group 400 from the vehicle DB 113 (Step S102).

The processor 101 selects a target vehicle used for provision of the primary adjustment force from the contract vehicle group 400 (Step S103).

The processor 101 determines the second adjustment rate (Step S104). Step S103 and Step S104 may not be executed in this order. For example, the processor 101 may execute Step S103 after executing Step S104. For example, in the example of FIG. 11, the processor 101 can select the target vehicle after determining the second adjustment rate, and determine the output electric power adjustment range of each charge-discharge device 300. In another example, the processor 101 may alternately execute Step S103 and Step S104 multiple times. Thereby, the second adjustment rate and the target vehicle can be determined in a step-by-step manner.

The processor 101 transmits a charge-discharge control command to the charge-discharge device 300 corresponding to the selected target vehicle (Step S105). Each information of a provision period, an adjustment request amount, a frequency adjustment range, and a second adjustment rate is included in the charge-discharge control command. Accordingly, the control process is completed.

When receiving the charge-discharge control command, the charge-discharge device 300 performs the charging-discharging of the electric vehicle 200 in accordance with the provision period, the adjustment request amount, the frequency adjustment range, and the second adjustment rate included in the charge-discharge control command. The charging-discharging of each target vehicle is performed, a forward flow or a reverse flow with respect to the electric power system is generated in accordance with the system frequency, and the primary adjustment force is provided.

### 5. Supplementary Note

The embodiment of the present disclosure is an example in all points and is not meant to be limiting. The scope of rights of the present invention is indicated not by the embodiment described above but by the claims, and includes the meanings of equivalents to the claims and all modifications within the scope thereof.

### DESCRIPTION OF REFERENCE SYMBOLS

10 Charge-discharge control system
20 Aggregator
30 Local TSO
40 Electric power market
50 Internet
100 Control Server
101 Processor
102 Non-volatile memory
103 Volatile memory
104 Communication interface
110 Control program
111 Contract information
112 First adjustment rate
113 Vehicle database (vehicle DB)
121 Acquisition portion
122 Selection portion
123 Determination portion
124 Output portion
200 Electric vehicle
300 Charge-discharge device
400 Contract vehicle group
410 Target vehicle group

What is claim is:

1-13. (canceled)

14. A control apparatus that controls charging-discharging of a vehicle group which includes a plurality of electric vehicles, the control apparatus comprising:
an acquisition portion that acquires an adjustment request amount indicating an output adjustable range which is a range in which output electric power of a charge-discharge device that performs charging-discharging of the electric vehicle is capable of being adjusted in response to a frequency variation of an electric power system, and
a determination portion that determines, based on the adjustment request amount acquired by the acquisition portion, a second adjustment rate which is smaller than a first adjustment rate determined for the vehicle group as an adjustment rate used in a charge-discharge control of an electric vehicle included in the vehicle group.

15. The control apparatus according to claim 14,
wherein the second adjustment rate is an adjustment rate for setting the output electric power of the charge-discharge device to a limit value of the adjustment request amount when a frequency of the electric power system changes to a specific frequency.

16. The control apparatus according to claim 15,
wherein the specific frequency is a limit value of a frequency adjustment range of the charge-discharge device when the charge-discharge device performs a frequency response operation by the first adjustment rate in an output electric power adjustment range determined for the vehicle group.

17. The control apparatus according to claim 15,
wherein the limit value of the adjustment request amount is rated output electric power of the charge-discharge device.

18. The control apparatus according to claim 14,
wherein the determination portion determines the second adjustment rate within a range defined by the first adjustment rate and a predetermined lower limit value of the second adjustment rate.

19. The control apparatus according to claim 18,
wherein the determination portion determines the second adjustment rate to be the lower limit value.

20. The control apparatus according to claim 19,
wherein the determination portion determines a control limit value of the output electric power of the charge-discharge device that is different from rated output electric power of the charge-discharge device.

21. The control apparatus according to claim 20,
wherein the control limit value is an output electric power value of the charge-discharge device corresponding to a specific frequency when the charge-discharge device performs a frequency response operation by the second adjustment rate.

22. The control apparatus according to claim 21,
wherein he specific frequency is a limit value of a frequency adjustment range of the charge-discharge device when the charge-discharge device performs a frequency response operation by the first adjustment rate in an output electric power adjustment range determined for the vehicle group.

23. The control apparatus according to claim 14, further comprising:
a selection portion that selects a target vehicle which is an electric vehicle as a target of a charge-discharge control by the second adjustment rate, based on an output electric power adjustment range determined for the vehicle group and the adjustment request amount of each of the plurality of electric vehicles included in the vehicle group.

24. The control apparatus according to claim 23,
wherein the selection portion selects the target vehicle so that a sum of the adjustment request amount of the plurality of target vehicles satisfies a condition based on the output electric power adjustment range.

25. A control method that controls charging-discharging of a vehicle group which includes a plurality of electric vehicles, the control method comprising:
a step of acquiring an adjustment request amount indicating an output adjustable range which is a range in which output electric power of a charge-discharge device that performs charging-discharging of the electric vehicle is capable of being adjusted in response to a frequency variation of an electric power system, and
a step of determining, based on the acquired adjustment request amount, a second adjustment rate which is smaller than a first adjustment rate determined for the vehicle group as an adjustment rate used in a charging-discharging control of an electric vehicle included in the vehicle group.

26. A control program for controlling charging-discharging of a vehicle group which includes a plurality of electric vehicles, the control program causing a computer to execute:
a step of acquiring an adjustment request amount indicating an output adjustable range which is a range in which output electric power of a charge-discharge device that performs charging-discharging of the electric vehicle is capable of being adjusted in response to a frequency variation of an electric power system, and
a step of determining, based on the acquired adjustment request amount, a second adjustment rate which is smaller than a first adjustment rate determined for the vehicle group as an adjustment rate used in a charging-discharging control of an electric vehicle included in the vehicle group.
